(19) United States
(12) Patent Application Publication
(10) Pub. No.: US 2011/0020504 A1
(43) Pub. Date: Jan. 27, 2011

(54) Crispy Jalapeno

(76) Inventor: Doehne Duckworth, Stowe, VT (US)

Correspondence Address: JAMES MARC LEAS;Law Office Of James Marc Leas, 37 BUTLER DRIVE, S. BURLINGTON, VT, 05403, US

(21) Appl. No.: 12/843,480

(22) Filed: Jul. 26, 2010

Related U.S. Application Data
(60) Provisional application No. 61/228,558, filed on Jul. 25, 2009.

(51) Int. Cl. A23L 1/212; A23L 3/40; A23L 1/01; A23P 1/00; A23L 3/44; A23P 1/08; A23L 1/015

(52) U.S. Cl. 426/102; 426/465; 426/438; 426/466; 426/385; 426/296; 426/640; 426/472

(57) ABSTRACT

A method of making crispy pepper chips includes providing a pepper. The method also includes slicing the pepper to form pepper slices. The method also includes cooking and dehydrating without burning to form crispy pepper chips.

### RELATED APPLICATIONS AND PRIORITY

This application claims the benefit of Provisional Patent Application 61/228,558, filed Jul. 25, 2009, incorporated herein by reference.

### BACKGROUND

Potato chips have been a great crispy snack food. They have been made by processes including cleaning, peeling, slicing, frying, and salting. The potato has such a structure that frying the sliced vegetable has produced a sufficiently crispy chip. Other food items, such as chicken, have been coated with batter and then fried to produce a product with a relatively crispy outer surface texture and leaving a soft inner texture. Many food items have not been successfully made into crispy chips, and the present application provides an improved processes for doing so.

### SUMMARY

One aspect of the present patent application is a method of making crispy pepper chips comprising providing a pepper. The method also includes slicing the pepper to form pepper slices. The method also includes cooking and dehydrating without burning to form crispy pepper chips.

Another aspect of the present patent application is a food, comprising a coated, cooked, and dehydrated crispy pepper portion.

### BRIEF DESCRIPTION OF THE DRAWINGS

FIGS. 1a-1b show side and front views respectively of a pepper chip sliced perpendicular to the axis of the pepper;

FIGS. 2a-2b show side and front views respectively of a pepper chip sliced at an obtuse angle to the axis of the pepper; and

FIGS. 3a-3b show side and front views respectively of a pepper chip sliced parallel to the axis of the pepper.

### DETAILED DESCRIPTION

The present application provides methods of making a crispy product from a hot pepper, such as a jalapeno pepper. One embodiment of the method makes jalapeno chips. Other hot peppers, such as habanero and serrano, can also be used. Mild peppers can also be used.

The present applicant found that Jalapeno chips made by processes of the present patent application are a great snack food for eating by themselves. The present applicant has also found other uses for the Jalapeno chips made by these processes, such as on top of soups and salads and baked potatoes. The chips add interesting texture to sandwiches as well as burgers. The jalapeno chips are also very good on baked items such as mac and cheese, green bean and other casseroles. Another way they are used is to crush them and use them as a coating on chicken, fish, shrimp, and pork prior to baking.

One method of making jalapeno chips is as follows: slice ten pounds of jalapeno peppers and add them to a solution that includes 1½ gallons of water and 15 drops of green food coloring. Soak the chips in this solution for 15-20 hours. The green food coloring contains FD&C yellow and blue food coloring. The green food coloring maintains the product color and also contains a small amount of malic acid and sodium benzoate which act as stabilizers or as preservatives. Next, drain the sliced jalapenos chips and coat them with a mixture of 50% rice flour and 50% corn starch. This coating helps make the product crispy after frying. Then fry the sliced jalapenos chips at approximately 350 degrees F. for about 4½ minutes in canola oil to remove moisture from the slices and adhere the coating. Other oils can also be used, including sunflower oil, safflower oil, peanut, vegetable, and rapeseed oil. Then drain the excess oil and bake the jalapeno chips in a 200 degree F. oven for about 5 minutes to dehydrate and form a uniformly crispy product without burning. Let the sliced jalapenos chips cool and apply a cheese coating. Shake off the excess cheese. A flavoring, such as one or more of the flavorings from the list below, can be included with the cheese coating. The finished jalapeno chips can then be heated gently to maintain low moisture until packaged and to provide low moisture in the package.

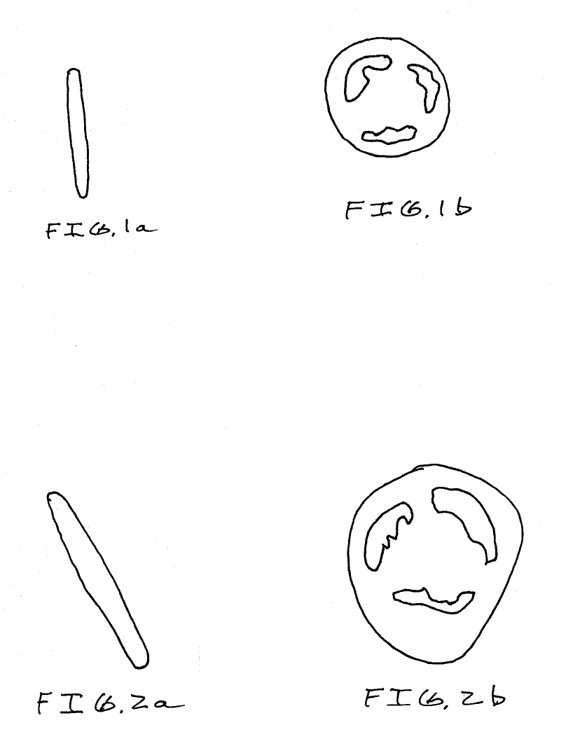

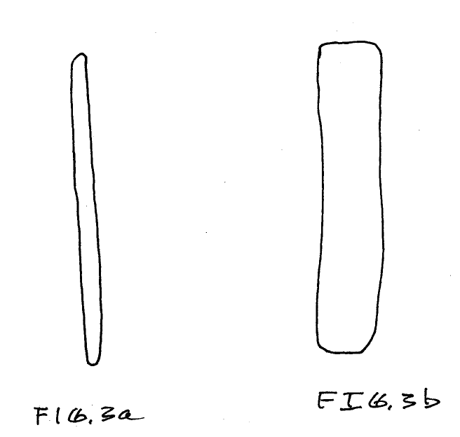

The jalapenos peppers can be sliced perpendicular to the axis, as shown in FIGS. 1a-1b to produce a circular shaped chip, at an obtuse angle to the axis to make chips having an oval shape, as shown in FIGS. 2a-2b, and parallel to the axis of the pepper to make a chip having a curved partial tube shape, as show in FIGS. 3a-3b.

The green food coloring that includes malic acid and sodium benzoate is for providing stabilizing and preserving so the packaged chips have a long shelf life. Other preservatives and/or stabilizers can be used, such as BHA and BHT.

Natural products can be used instead of the food coloring to provide stabilizing and preserving. One natural product that worked for the present applicant was citric acid. He used about a tablespoon of citric acid in about a 1½ gallons of water in an experiment and found that the product was crispy for at least two months. Other natural products can be used, such as ascorbic acid.

Applicant also found that preservatives and stabilizers can be omitted while retaining long packaged shelf life.

After soaking in the solution the slice becomes more rigid. Thus, the slice can be cooked without bending or sticking to other slices. Providing the slices with more rigidity allows them to remain separate from each other and avoids them sticking to each other.

The frying can be accomplished with deep frying, kettle frying, chip pan frying, pressure frying, and low temperature vacuum frying. Alternatively, frying can be omitted, and the chips can be baked instead. Alternatives to frying can be used that reduce the amount of oil absorbed by the product, such as the hot air expansion process provided by Baker Perkins, Ltd., Grand Rapids, Mich.

The cheese can be a cheese powder, such as cheddar, goat cheese, blue cheese, gorgonzola or any other kind of cheese powder.

Other flavorings can be added, including red onion, pesto, Thai 7 Spice, sea salt, black pepper, herbs, rosemary, roasted red pepper, salsa, mesquite, vinegar, spicy That, chipotle chili, barbeque, dill pickle, garlic, sour cream, chive, onion, cinnamon, sugar, ranch, cayenne, cumin, habanero, serrano, smoked, mediterranean, sesame, shallot, moroccan, tequila, beer, lime, and nacho. These and other flavorings can be added either individually or in combinations. For example, salt and pepper, salt and vinegar, sour cream and onion, sea salt and cumin, garlic and herb, roasted red pepper and goat cheese, tequila and lime, cheddar and beer, and gorgenzola and red onion can be added. For example, habanero powder can be included to increase the scoville unit of the finished chip.

The present applicant found that when the product was sealed in an air tight package it remained stable for the full two month duration of one experiment. Later additional testing showed that it remained stable for at least six months with a cheese powder flavoring and at least one year with a ranch seasoning.

Another aspect of the present patent application is a commercial product that includes jalapeno pepper chips in a package. Air in the package has a moisture content that is sufficiently low to preserve crispness of the chips. Applicant expects that a humidity lower than 50% would work. Other gases can be used instead of air, such as nitrogen and carbon dioxide.

Another method of making the jalapeno chips is as follows: wash ten pounds of jalapeno peppers. Slice the peppers and separate the seeds, for example by adding them to water and stirring. Next, drain the sliced jalapenos chips and let them partially dry. Mechanical methods of separating the seeds can also be used. For example, a vibrating table, screen or conveyor belt can be used to separate the seeds from remaining portions of the slice. Next coat the slices with a powder coating, such as corn starch or a liquid coating, such as batter. In one embodiment the batter contains flour, water, egg and spices. In another it contains cornstarch and water. In a third it contains flour, eggs, and beer. This coating helps make the product crispy after frying. Then fry the sliced jalapenos chips at approximately 350 degrees F. for about 4½ minutes in canola oil. Other oils can also be used, including sunflower oil, safflower oil, and rapeseed oil. Then drain the excess oil and bake the jalapenos chips in a 225 degree F. oven for about 15 minutes to provide a uniformly crispy product. Baking is performed on sheet pans with an absorbent layer to absorb oil, such as paper towel. While still hot apply a cheese powder coating. A tub, bin, or drum seasoner can be used to apply the cheese powder. Shake off the excess cheese. The cheese powder can be cheddar, goat cheese, blue cheese, gorgonzola or any other kind of cheese powder. A flavoring, such as provided in the list herein above, can be included with the cheese coating or used instead of the cheese coating.

In one embodiment the jalapeno chips are kept in a low moisture environment or heated gently to maintain low moisture until packaged and to provide low moisture in the package.

In another embodiment, the chips are kept at a temperature of about 160 degrees F. for six hours to drive out moisture so chips become crisp without burning or losing all of their pepper color. A Proofer oven was used for this dehydration process. Holes were drilled in the top of the Proofer oven to allow moisture to escape.

Alternative processes, such as providing dried air around the chips and providing a low pressure ambient can be used for more quickly dehydrating the pepper chips without burning In another embodiment, the dehydration is provided to the sliced cooked peppers by freeze drying.

In one alternative, instead of frying, the chips can be sprayed lightly with oil before the baking step.

Another method of making the jalapeno chips that reduces or eliminates the use of oil is as follows: slice ten pounds of jalapeno peppers. Separate the seeds, as described herein above. Next introduce the sliced peppers into a machine, such as the hot air expansion oven from Baker Perkins, in Grand Rapids, Mich. Optionally, a thin coating of oil can then be sprayed on if desired. A liquid cheese can be included with the oil to make a slurry that is sprayed on. Other flavors can be included with the oil. Other adherent liquids can be used instead of the oil, such as a polyol based syrup. Alternatively, a cheese powder coating can be applied. A tub, bin, or drum seasoner can be used to apply the cheese powder. Shake off the excess cheese. A flavoring, such as provided in the list herein above, can be included with the cheese coating. The chips are then subject to a dehydration process, such as heating in the proofer oven at 160 degrees F. for four hours. The finished jalapeno chips are then packaged while still warm to maintain low moisture until packaged and to provide low moisture in the package to maintain the chips in a crispy state.

In one experiment, after frying, the jalapeno chips were placed in a dehydrator at about 160 degrees F. for four hours. The dehydrator had a fan that drew heated dry air across the jalapeno chips, thereby reducing their moisture content. This step was used instead of the above described baking The results were comparable to the frying and baking method.

While the disclosed methods and systems have been shown and described in connection with illustrated embodiments, various changes may be made therein without departing from the spirit and scope of the invention as defined in the appended claims. Nothing in the above specification is intended to limit the invention more narrowly than the appended claims. The examples given are intended only to be illustrative rather than exclusive.

1. A method of making crispy pepper chips comprising:
a. providing a pepper;
b. slicing said pepper to form pepper slices;
c. cooking and dehydrating without burning to form crispy pepper chips.

2. A method as recited in claim 1, wherein said pepper has an axis, wherein said slicing includes at least one from the group consisting of slicing parallel to said axis and slicing perpendicular to said axis.

3. A method as recited in claim 1, wherein said pepper has an axis, wherein said slicing includes slicing at an obtuse angle to said axis.

4. A method as recited in claim 1, wherein said cooking includes frying.

5. A method as recited in claim 4, wherein said frying includes one from the group consisting of deep frying, kettle frying, chip pan frying, pressure frying, and low temp vacuum frying.

6. A method as recited in claim 1, wherein said dehydrating includes at least one from the group consisting of baking in an oven and baking in a proofer.

7. A method as recited in claim 1, wherein said dehydrating includes freeze drying.

8. A method as recited in claim 1, wherein said cooking includes frying, wherein said dehydrating follows said frying.

9. A method as recited in claim 1, further comprising applying a coating before doing said cooking.

10. A method as recited in claim 1, wherein said applying a coating includes applying corn starch.

11. A method as recited in claim 1, further comprising applying a cheese after said cooking.

12. A method as recited in claim 1, further comprising applying a flavoring.

13. A method as recited in claim 12, wherein said applying a flavoring includes applying at least one from the group consisting of red onion, pesto, Thai 7 Spice, sea salt, black pepper, herbs, rosemary, roasted red pepper, salsa, mesquite, vinegar, spicy That, chipotle chili, barbeque, dill pickle, garlic, sour cream, chive, onion, cinnamon, sugar, ranch, cayenne, cumin, habanero, serrano, smoked, mediterranean, sesame, shallot, moroccan, tequila, beer, lime, a cheese, and nacho.

14. A food as recited in claim 1, wherein pepper includes at least one from the group consisting of jalapeno, habanero, and passilla.

15. A method as recited in claim 1, wherein said pepper slices have seeds, further comprising separating said seeds from remaining portions of said pepper slices.

16. A method as recited in claim 1, wherein said cooking includes oil free cooking.

17. A food, comprising a coated, cooked, and dehydrated unburned crispy pepper portion.

18. A food as recited in claim 17, wherein said crispy pepper portion includes a chip sliced from said pepper.

19. A food as recited in claim 18, wherein said crispy pepper chip includes a first coating.

20. A food as recited in claim 19, wherein said first coating includes flour.

21. A food as recited in claim 20, wherein said first coating includes corn starch.

22. A food as recited in claim 17, wherein crispy pepper portion includes at least one from the group consisting of a crispy jalapeno pepper slice, a crispy habanero slice, and a crispy serrano slice.
